(19) United States
(12) Patent Application Publication
(10) Pub. No.: US 2025/0183748 A1
(43) Pub. Date: Jun. 5, 2025

(54) ROTATING DEVICE

(71) Applicant: MINEBEA MITSUMI Inc., Nagano (JP)

(72) Inventors: Yukimasa MATSUMURA, Kitasaku-gun (JP); Koichiro HIRABAYASHI, Kitasaku-gun (JP); Jun OHMURA, Kitasaku-gun (JP); Bora IN, Kitasaku-gun (JP)

(21) Appl. No.: 18/844,124

(22) PCT Filed: Dec. 21, 2022
(86) PCT No.: PCT/JP2022/047056

§ 371 Date: Sep. 5, 2024

(30) Foreign Application Priority Data
Mar. 9, 2022 (JP) 2022-036350

(51) Int. Cl. H02K 5/08; H02K 5/22; H02K 7/116

(52) U.S. Cl. CPC H02K 5/08; H02K 5/225; H02K 7/1166

(57) ABSTRACT

A rotating device includes a motor, gears, a first molded member formed of an elastic resin, a first non-molded member formed of an elastic resin, and a housing. The motor includes a rotation shaft and a frame. The housing includes a first inner surface in a rotation shaft direction of the motor. The frame includes a tube including two opening portions in the rotation shaft direction of the motor, and a first part covering one of the two opening portions. The first part of the frame connects to the first inner surface of the housing opposing the first part of the frame via the non-molded member in the rotation shaft direction of the motor. A part of the frame is supported by a portion of the housing via the first molded member.

### TECHNICAL FIELD

The present invention relates to a rotating device.

### BACKGROUND ART

In a rotating device such as a gear box with a motor, a technology is known for holding the motor by using an elastic member in order to suppress noise and vibration.

### CITATION LIST

### Patent Literature

PTL 1: JP 2015-186278 A

### SUMMARY OF INVENTION

### Technical Problem

However, when an elastic member is used to hold the motor, the vibration may not be sufficiently reduced.

An object is to provide a rotating device capable of suppressing vibration in one aspect.

### Solution to Problem

In one aspect, a rotating device includes a motor, a gear, a first molded member formed of an elastic resin, a first non-molded member formed of an elastic resin, and a housing. The motor includes a rotation shaft and a frame. The housing includes a first inner surface in a rotation shaft direction. The frame includes a tube including two opening portions in the rotation shaft direction of the motor, and a first part covering one of the two opening portions of the tube. The first part of the frame connects to the first inner surface of the housing opposing the first part of the frame via the non-molded member in the rotation shaft direction of the motor. A portion of the frame is supported by a part of the housing via the first molded member.

One aspect enables vibration to be suppressed.

### BRIEF DESCRIPTION OF DRAWINGS

FIG. 1 is a plan view illustrating an example of a rotating device according to an embodiment.

FIG. 2 is a side view illustrating an example of the rotating device according to the embodiment.

FIG. 3 is a bottom view illustrating an example of the rotating device according to the embodiment.

FIG. 4 is a perspective view with a first housing removed from the rotating device according to the embodiment.

FIG. 5 is a plan view with the first housing removed from the rotating device according to the embodiment.

FIG. 6 is a perspective view illustrating an example of the first housing according to the embodiment.

FIG. 7 is a perspective view illustrating an example of a second housing with a resin member attached according to the embodiment.

FIG. 8 is an enlarged plan view illustrating an example of an arrangement of the rotating device according to the embodiment.

FIG. 9 is an enlarged plan view illustrating an example of a positional relationship between a housing, a motor, an O-ring, and an adhesive according to the embodiment.

FIG. 10 is an enlarged cross-sectional view illustrating an example of the rotating device according to the embodiment.

FIG. 11 is an exploded perspective view illustrating an example of a coupling state between a housing, an adhesive, and a motor according to the embodiment.

FIG. 12 is a perspective view illustrating an example of a motor according to a modified example.

FIG. 13 is a side view illustrating an example of a rotating device according to a modified example.

### DESCRIPTION OF EMBODIMENTS

Hereinafter, an embodiment of the rotating device disclosed in the present application will be described in detail based on the drawings. The relationship between the dimensions of each element and the ratio of each element in the drawings may differ from reality. The drawings may include parts having different dimensional relationships and ratios. To facilitate description, each drawing may be illustrated by using a coordinate system. In the coordinate system, the extension direction of a rotation shaft 31 of a motor 3 described below is defined as an X-axis direction, and the extension direction of an output shaft 51 described below orthogonal to the rotation shaft 31 is defined as a Z-axis direction.

### EMBODIMENTS

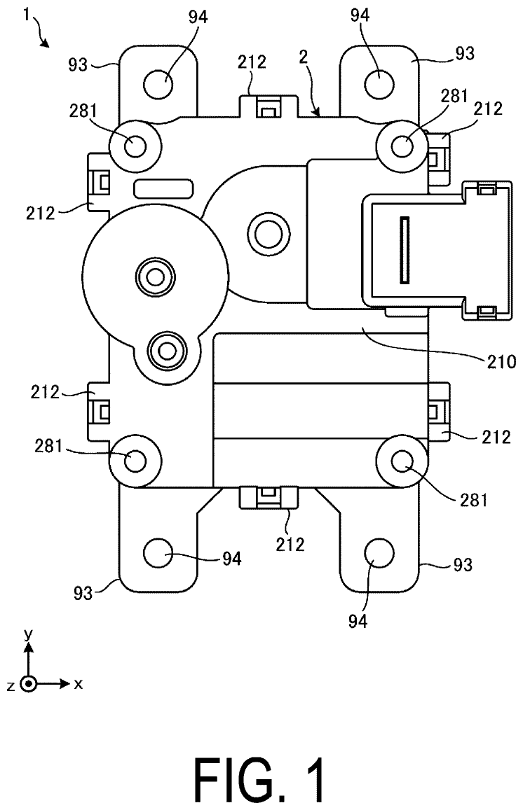

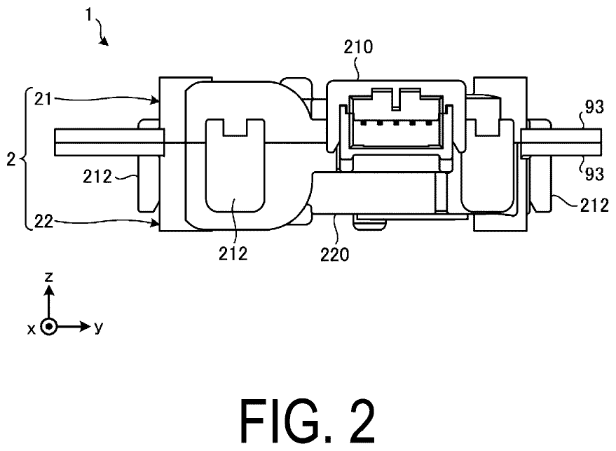

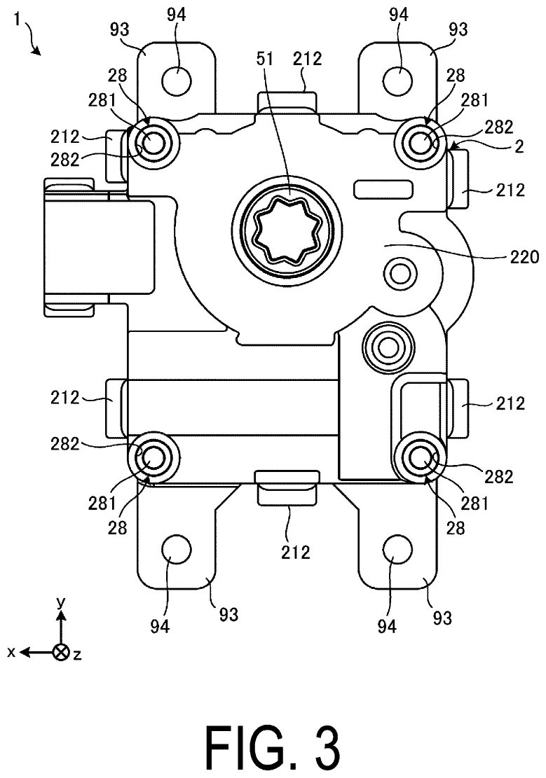

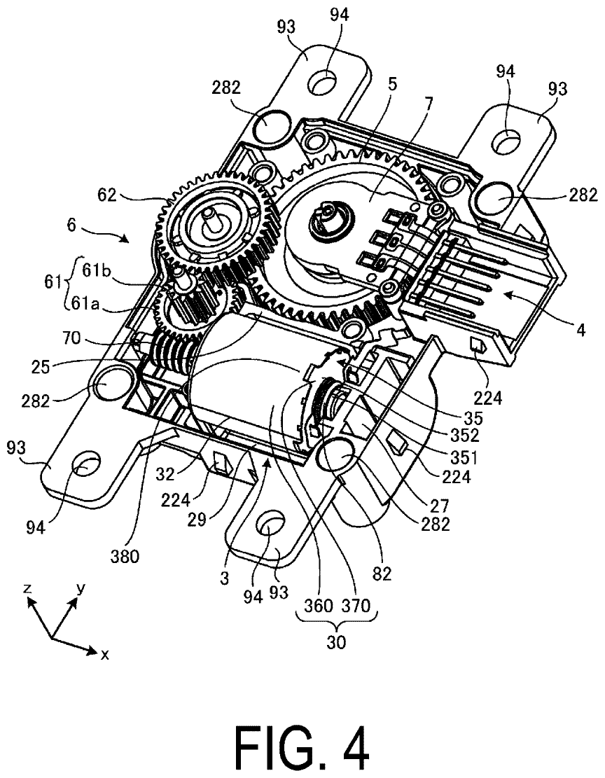

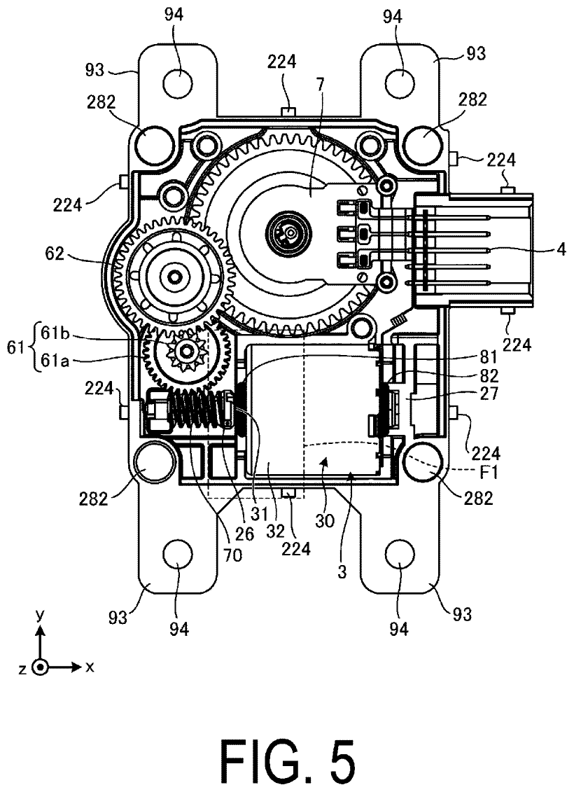

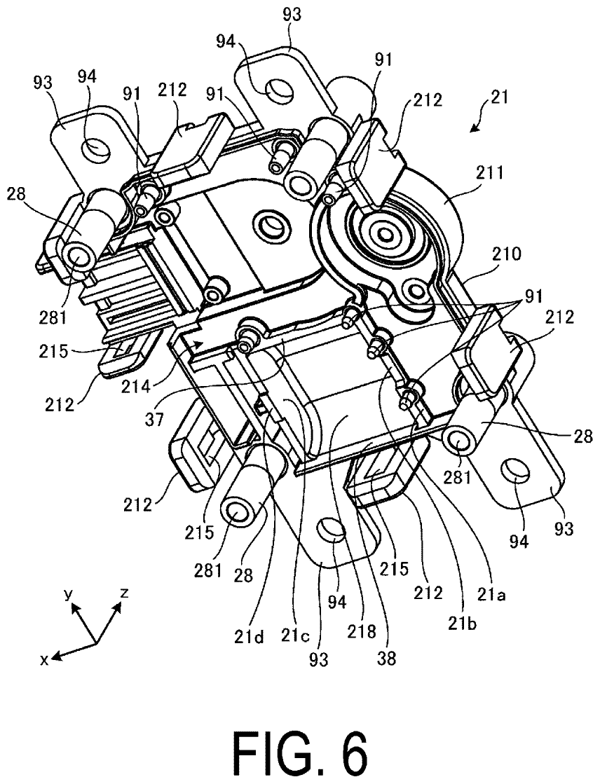

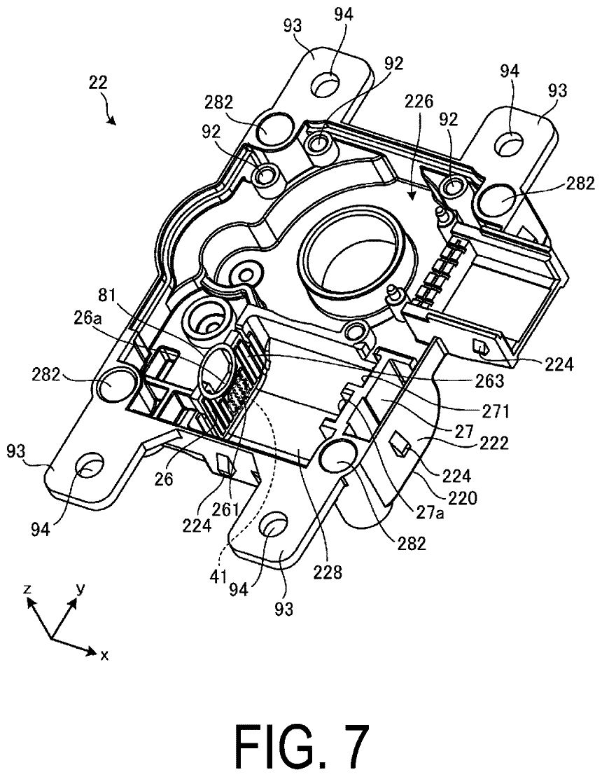

FIG. 1 is a plan view illustrating an example of a rotating device according to an embodiment. FIG. 2 is a side view illustrating an example of the rotating device according to the embodiment. FIG. 3 is a bottom view illustrating an example of the rotating device according to the embodiment. FIG. 4 is a perspective view with a first housing removed from the rotating device according to the embodiment. FIG. 5 is a plan view with the first housing removed from the rotating device according to the embodiment. FIG. 6 is a perspective view illustrating an example of the first housing according to the embodiment. FIG. 7 is a perspective view illustrating an example of a second housing with a resin member attached according to the embodiment.

A rotating device 1 according to the embodiment can be suitably used as an actuator used in, for example, an air conditioning system for a vehicle, and can control the rotating operation of a louver for controlling air volume, or the like.

As illustrated in FIGS. 1 to 3, the rotating device 1 includes the motor 3 illustrated in FIGS. 4 and 5, a plurality of gears (hereinafter referred to as a gear group) 6 for transmitting power from the motor 3, a sensor 7 for detecting the rotation angle of an output gear 5 included in the gear group 6, or the like.

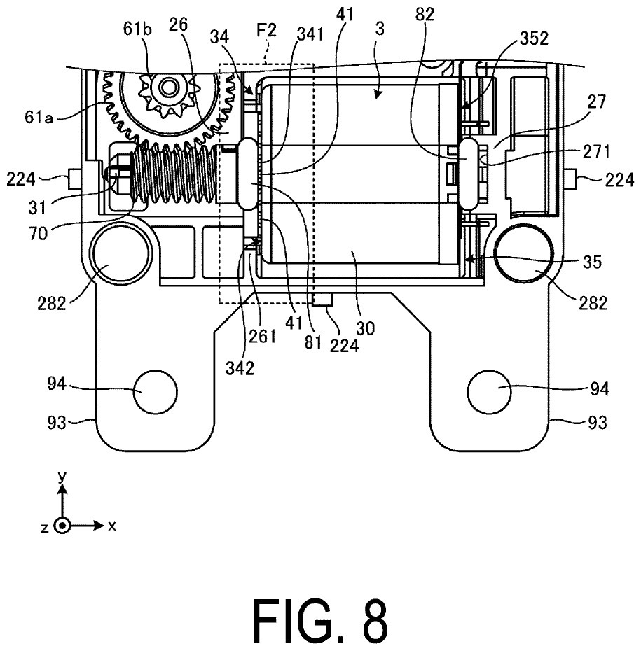

The gear group 6 includes a worm gear 70 attached to the rotation shaft 31 (see FIG. 8) of the motor 3, a first transmission gear 61, a second transmission gear 62, and the output gear 5. In this case, as illustrated in FIG. 4, rotation of the worm gear 70 is transmitted to a helical gear 61a of the first transmission gear 61 and to the second transmission gear 62 via a gear 61b having a smaller diameter than the helical gear 61a and being provided coaxially with the helical gear 61a. Rotation of the second transmission gear 62 is transmitted to the output gear 5. The output gear 5 is provided with the output shaft 51 (FIG. 3). The rotation shafts of the first transmission gear 61 and the second transmission gear 62 each extends in the direction of the output shaft 51 (Z-axis direction) intersecting with the rotation shaft direction of the worm gear 70 (X-axis direction).

Thus, the rotation of the motor 3 is decelerated by a predetermined reduction ratio and output from the output shaft 51 to the outside. The rotation angle of the output gear 5 is detected by the sensor 7. Information about the rotation angle of the output gear 5 detected by the sensor 7 is transmitted to the outside via, for example, a terminal group 4 illustrated in FIGS. 4 and 5. The sensor 7 may detect the rotation speed instead of the rotation angle of the output gear 5, or may detect both the rotation angle and the rotation speed. In the present embodiment, a DC motor is used as the motor 3, but a brushless motor or a stepping motor may be used. When a brushless motor or a stepping motor is used, the sensor 7 need not be required at the rotating device 1.

As illustrated in FIG. 2, a housing 2 includes a first housing 21 and a second housing 22 opposing each other in the Z-axis direction. That is, the housing 2 is constituted by coupling the first housing 21 including an opening portion 214 (FIG. 6) and the second housing 22 including an opening portion 226 (FIG. 7) with the opening portions 214 and 226 opposing each other.

As illustrated in FIGS. 2 and 6, the first housing 21 includes a first surface part 210 serving as a top surface part of the housing 2, and a first side wall part 211 provided at an outer peripheral part of the first surface part 210. The opening portion 214 is surrounded by the first side wall part 211. On the other hand, as illustrated in FIGS. 3 and 7, the second housing 22 includes a second surface part 220 serving as a bottom surface part of the housing 2 and a second side wall part 222 provided at an outer peripheral part of the second surface part 220. The opening portion 226 is surrounded by the second side wall part 222. The housing 2 is formed of an elastic or deformable resin material such as polypropylene, polyethylene terephthalate, ABS, polycarbonate, or the like.

As illustrated in FIG. 6, the first housing 21 includes a plurality of engagement parts 212 extending to the second housing 22 side. The plurality of engagement parts 212 are integrally formed at the outer peripheral part of the first side wall part 211. Such an engagement part 212 includes an engagement recess portion 215. On the other hand, the second housing 22 includes a plurality of projections (hereinafter referred to as engagement projections) 224 as illustrated in FIG. 7. The plurality of projections 224 corresponding to each of the engagement parts 212 of the first housing 21 are integrally formed at the second side wall part 222. Such an engagement projection 224 engages with the engagement recess portion 215 of the engagement part 212.

Thus, the housing 2 is formed by the first housing 21 and the second housing 22 abutting each other (see FIG. 2). In other words, by engaging the engagement projection 224 of the second housing 22 with the hole portion of the engagement part 212 of the first housing 21, the first housing 21 and the second housing 22 are integrated to form the housing 2 accommodating the above-described motor 3 and the gear group 6, and the like. In FIG. 2, the engagement projection 224 of the second housing 22 is hidden from view by the engagement part 212 of the first housing 21.

Although the first housing 21 is provided with the engagement part 212 and the second housing 22 is provided with the engagement projection 224 in the present embodiment, the second housing 22 may be provided with the engagement part 212 and the first housing 21 may be provided with an engagement projection 224.

Further, as illustrated in FIG. 6, the first housing 21 is provided with a plurality of projection parts 91 for positioning. The second housing 22 is provided with a plurality of fitting holes 92 corresponding to the plurality of projection parts 91 one to one of the first housing 21, as illustrated in FIG. 7. In a state with the first housing 21 and the second housing 22 abutting each other, the projection parts 91 are fitted to the fitting holes 92 one by one.

Further, as illustrated in FIGS. 6 and 7, pieces (hereinafter referred to as joining pieces) 93 protruding outward are formed at both end parts of one side of the first housing 21 and the second housing 22 respectively. The joining piece 93 is provided with a hole portion (hereinafter referred to as a coupling hole) 94 inserted by a fastening tool (not illustrated) as a predetermined fixing member. The joined first housing 21 and the second housing 22 are firmly coupled by the predetermined fastening tool via the four coupling holes 94 to constitute the integrated housing 2.

The housing 2 described above, in the present embodiment, is provided with a projecting part 28 at the corner of the first side wall part 211 forming the outer peripheral part of the first housing 21, and with a second through-hole 282 at the corner of the second housing 22. That is, each of the cylindrical projecting parts 28 has a first through-hole 281 enabling insertion of a fastener such as a bolt and screw, for example, and protrudes from the first surface part 210 in the first housing 21. The second housing 22 is provided with second through-holes 282 each engaged with the projecting part 28.

A plurality of projecting parts 28 are provided, and a plurality of second through-holes 282 are provided accordingly. The plurality of projecting parts 28 are provided at the plurality of (four) corners of the first housing 21, and the plurality of second through-holes 282 are also provided in the plurality of (four) corners of the second housing 22. In the present embodiment, the first surface part 210 of the first housing 21 and the second surface part 220 of the second housing 22 each has a substantially rectangular shape in a plan view, and the projecting part 28 and the second through-hole 282 are provided at each of the four corners.

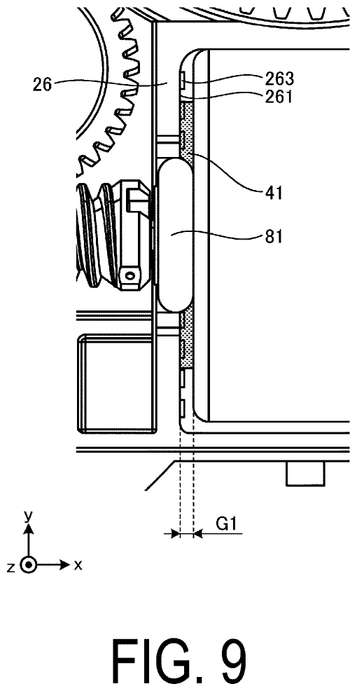

Next, a holding structure of the motor 3 in the present embodiment will be described with reference to FIGS. 4, 5, 7, 8, and 9. FIG. 8 is an enlarged plan view illustrating an example of an arrangement of the rotating device according to the embodiment. FIG. 9 is an enlarged plan view illustrating an example of a positional relationship between a housing, a motor, an O-ring, and an adhesive according to the embodiment. FIG. 8 is an enlarged view of the part illustrated in a frame F1 of FIG. 5. FIG. 9 is an enlarged view of the part illustrated in a frame F2 of FIG. 8.

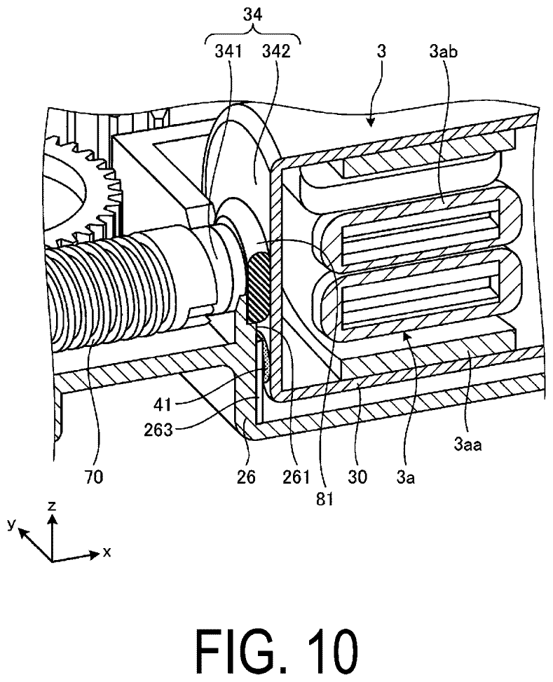

First, the configuration of the motor 3 will be briefly described. As illustrated in FIGS. 4 and 5, the motor 3 in the present embodiment includes the rotation shaft 31 and a frame 30 for accommodating a function section 3a illustrated in FIG. 10. FIG. 10 is an enlarged cross-sectional view illustrating an example of the rotating device according to the embodiment. Here, the function section 3a indicates a set of components necessary for driving the motor 3 except for the rotation shaft 31. When the motor is a brushed motor, the function section 3a includes a magnet, an amateur (rotor) including a coil or an electromagnetic steel plate (magnetic body), a bracket, a brush provided at the bracket, a commutator, or the like. When the motor is a brushless motor, the function section 3a includes a stator with a coil or an electromagnetic steel plate (magnetic body), a magnet, or the like. That is, the motor 3 includes the frame 30, the rotation shaft 31 coupled to the worm gear 70, and the function section 3a. FIG. 10 illustrates an amateur (rotor) including a magnet 3aa and a coil 3ab.

As illustrated in FIGS. 4 and 5, the frame 30 includes a tubular body 32 extending in the axial direction (X-axis direction) of the motor 3 and end parts (first end part 34, second end part 35) in the X-axis direction. As illustrated in FIG. 8, the first end part 34 is an end part at the worm gear 70 side, and the second end part 35 is an end part at the opposite side from the worm gear 70. The tubular body 32 is an example of a tube.

As illustrated in FIG. 4, the frame 30 includes a tube including two opening portions and a first part covering one of the two opening portions. Specifically, the frame 30 includes a tubular frame main body 360 having a tube and a bottom part as a first part covering one of the opening portions of the tube, and a plate 370 as a second part covering the other opening portion of the tube of the frame main body 360. The bottom part and the plate 370 are examples of the first part and the second part of the frame. The function section 3a and a portion of the rotation shaft 31 are accommodated at a housing constructed with the frame main body 360 and the plate 370. FIG. 4 illustrates a portion of a bracket 380 being a component of the function section 3a. The frame main body 360 is an example of the tubular body 32.

The bracket 380 holds a brush in contact with the commutator attached to the rotation shaft 31, or a spring for biasing the brush against the commutator, or the like. The frame main body 360 and the plate 370 accommodates the bracket 380 by sandwiching a portion of the bracket 380. The outer surface of the motor 3 includes the outer surface of the frame 30 and the outer surface of a portion of the bracket 380 sandwiched between the frame main body 360 and the plate 370. That is, the first end part 34 is formed by the end part of the frame main body 360 at the worm gear 70 side, and the second end part 35 is formed by the plate 370.

The frame 30 has a first outer side surface 342 at the first end part 34 side and a second outer side surface 352 at the second end part 35 side. The first outer side surface 342 and the second outer side surface 352 are surfaces (e.g., vertical surfaces) intersecting with the axial direction. Note that the first outer side surface 342 is another example of the first part of the frame, and the second outer side surface 352 is another example of the second part of the frame.

As illustrated in FIGS. 8 to 10, the first end part 34 includes, in addition to the first outer side surface 342, a first bearing part 341 accommodating a first bearing 349. The first bearing part may have a shape with a portion of the first outer side surface 342 protruding. The first bearing 349 rotatably supports the rotation shaft 31 at the worm gear 70 side. In FIGS. 8 to 10, the first bearing 349 is hidden from view by the first bearing part 341 and is not visible. The rotation shaft 31 protrudes from the first bearing part 341, and the worm gear 70 meshing with the first transmission gear 61 is attached to the protruding part.

As illustrated in FIG. 4, the second end part 35 may include a second bearing part 351 accommodating a second bearing 359 in addition to the second outer side surface 352. The second bearing part 351 may have a shape with a portion of the second outer side surface 352 protruding. The second bearing 359 rotatably supports the rotation shaft 31 at the opposite side of the worm gear 70. Also in FIG. 4, the second bearing 359 is hidden from view by the second bearing part 351 and is not visible. The first bearing part 341 is an example of the first end part at the first part side of the frame, and the second bearing part 351 is an example of the second end part at the second part side of the frame.

In the embodiment, an O-ring 81 is attached to the first bearing part 341, and an O-ring 82 is attached to the second bearing part 351. The O-rings 81 and 82 are formed in an annular shape of, for example, an elastic resin. The O-rings 81 and 82 are formed of rubber, for example, but at least one of a rubber-based resin member, silicon-based resin member, modified silicon-based resin member, urethane-based resin member, or epoxy-based resin member can be used. The O-ring 81 is an example of a first molded member, and the O-ring 82 is an example of a second molded member.

As illustrated in FIG. 5, a region 228 is provided at the second housing 22, and the motor 3 is arranged in the region 228 (see FIG. 4). The region 228 is surrounded by a first holding wall 26, a second holding wall 27, a wall 25, and a wall 29. The first holding wall 26 as a wall part and the second holding wall 27 as a wall part, oppose the first end part 34 and the second end part 35 of the frame 30 of the motor 3, respectively. The wall 25 is an inner wall provided inside the housing 22. The wall 29 is formed of a portion of the side wall part of the housing 22 and, in the illustrated example, formed of a portion of the second side wall part 222.

The first holding wall 26 is formed with a first recess portion 26a recessed toward the interior of the second housing 22. The first bearing part 341 of the motor 3 surrounded by the O-ring 81 is fixed to the first recess portion 26a. The second bearing part 351 of the motor 3 surrounded by the O-ring 82 is fixed to a second recess portion 27a formed at the second holding wall 27. That is, the first recess portion 26a of the second housing 22 holds the first bearing part 341 of the frame 30 via the O-ring 81 in the direction intersecting with the rotation shaft 31 of the motor 3 (e.g., in the vertical direction (Z-axis direction)) and in the direction of the rotation shaft 31. The second recess portion 27a of the second housing 22 holds the second bearing part 351 of the frame 30 via the O-ring 82 in the direction intersecting with the rotation shaft 31 of the motor 3 (e.g., in the vertical direction (Z-axis direction)).

In this case, the first recess portion 26a and the first outer side surface 342 from each other in the direction (X-axis direction) of the rotation shaft 31 of the motor 3. The second recess portion 27a and the second outer side surface 352 apart from and oppose each other in the direction (X-axis direction) of the rotation shaft 31 of the motor 3. A first gap G1 is formed between the first recess portion 26a and the first outer side surface 342. A second gap G2 is formed between the second recess portion 27a and the second outer side surface 352. In this case, the O-ring 81 is held, at the housing 2, sandwiched between the second housing 22 and the frame 30. The first recess portion 26a is an example of a first support part of the housing 2. The second recess portion 27a is an example of a second support part of the housing 2.

As illustrated in FIG. 6, the first housing 21 is provided with a region 218, the motor 3 being arranged in the region 218. The region 218 is surrounded by a third holding wall 21a as a wall part, a fourth holding wall 21c as a wall part, a wall 37, and a wall 38. The third holding wall 21a and the fourth holding wall 21c oppose the first end part 34 and the second end part 35 of the frame 30 of the motor 3, respectively. The wall 37 is an inner wall provided inside the first housing 21. The wall 38 is formed of a portion of the side wall part 211 of the first housing 21. A third recess portion 21b recessed toward the inside of the first housing 21 is formed in the third holding wall 21a. The first bearing part 341 of the motor 3 is fixed to the third recess portion 21b via the O-ring 81. A protruding part 21d projecting toward the outside of the first housing 21 is formed in the fourth holding wall 21c. The second bearing part 351 is fixed to the protruding part 21d via the O-ring 82.

In such a configuration, in the radial direction (Y-axis direction) of the motor 3 accommodated in the housing 2, reaction force of the gears 5, 6 engaged with the worm gear 70 are applied to the rotation shaft 31 of the motor 3 via the worm gear 70. The displacement of the motor 3 by this reaction force may cause change of the engagement of the worm gear 70 with the gears 6, thereby generating an abnormal sound.

Thus, in the present embodiment, the displacement of the motor 3 in the radial direction and the propagation of vibration accompanied by the displacement are suppressed, by using an elastic adhesive 41 being a non-molded member, together with the O-rings 81 and 82 being molded members harder than the adhesive 41. Thus, in the present embodiment, the displacement of the motor 3 in the radial direction and the propagation of vibration accompanied by the displacement is suppressed, by using the adhesive 41 being a non-molded member easy to deform, together with the O-rings 81 and 82 being a molded members harder to deform than the adhesive 41. Additionally, the generation of abnormal sound due to the propagation of vibration in the rotation shaft direction of the motor 3 is suppressed. In addition, a non-molded member formed of a material different from the material forming the molded member is interposed (filled) between the housing and the motor, thereby suppressing the propagation of vibration to the housing in the frequency band difficult to be reduced by the molded member. The elastic adhesive 41 is an example of a first non-molded member formed of an elastic resin. The elastic adhesive 41 may be denoted as the elastic first adhesive 41 or simply as the adhesive 41.

The adhesive 41 is interposed between the surface of a holding part (first holding wall 26) intersecting with the axial direction, and the first end part 34 of the frame 30. Specifically, as illustrated in FIG. 9, the adhesive 41 is located at the gap G1 between the first outer side surface 342 and a first holding surface 261 of the first holding wall 26. Thus, the motor 3 is coupled to the second housing 22 via the adhesive 41. The first holding surface 261 is an example of a first inner surface, and the gap G1 is an example of a first gap. An elastic second adhesive 42 is an example of a second non-molded member formed of a resin having elasticity.

As the adhesive 41, at least one of a known rubber-based adhesive, a silicon-based adhesive, a modified silicon-based adhesive, a urethane-based adhesive, or an epoxy-based adhesive can be suitably used, and the adhesive 41 has predetermined elasticity even when solidified. That is, in the present embodiment, the adhesive 41 is a member with a liquid adhesive (adhesive 41) applied between the motor 3 and the holding part (first holding wall 26 and second holding wall 27) being cured.

The elastic first adhesive 41 has a higher adhesive force than, for example, the O-ring 81. In other words, the force required to remove the O-ring 81 from the second housing 22 or motor 3 is smaller than the force required to remove the adhesive 41 from the second housing 22 or motor 3.

Also, the motor 3 supported by the housing 2 via the O-rings 81 and 82 is not in contact with the first housing 21 and the second housing 22. The first adhesive 41 having elasticity is disposed between the motor 3 and a part not in contact with the motor 3 at the second housing 22. This can further suppress the vibration of the motor 3 propagating to the housing 2. In the present embodiment, one housing may be the second housing 22 and the other housing may be the first housing 21.

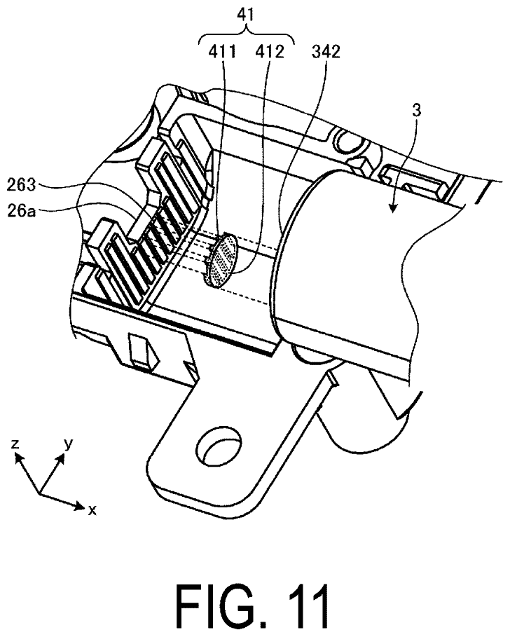

In the embodiment, an uneven shape 263 as illustrated in FIG. 11 is formed at the first holding surface 261 of the second housing 22. FIG. 11 is an exploded perspective view illustrating an example of a coupling state between the housing, the adhesive and the motor in an embodiment. The part of the first holding surface 261 having the uneven shape 263 illustrated in FIG. 11 is integrally molded with, for example, the second housing 22. The part of the first holding surface 261 having the uneven shape 263 includes a plurality of protruding parts in a direction (Y-axis direction) orthogonal to, for example, the rotation shaft direction (X-axis direction) of the motor 3. The part of the first holding surface 261 having the uneven shape 263 may include a plurality of recess portions. The plurality of protruding parts or the plurality of recess portions may be formed in a direction intersecting with the X and Y axes (for example, orthogonal to the X and Y axes (Z-axis direction)) or in any other direction.

In an embodiment, the adhesive 41 covers a part of the first holding surface 261 having the uneven shape 263 in the X-axis direction. In this case, as illustrated in FIG. 11, the uneven shape 263 formed in a part of the first holding surface 261 is transferred to a first surface 411 of the hardened adhesive 41. The shape of the first outer side surface 342 of the motor 3 is transferred to a second surface 412. In the example illustrated in FIG. 11, as a result of transferring the flat shape 342 to the second surface 412, the second surface 412 is also formed into a flat shape. It should be noted that the O-ring 81 may be configured to contact the part of the first holding surface 261 having the uneven shape 263 in any direction.

In this way, a plurality of recess portions or a plurality of protruding parts are formed side by side over the region contacted by the O-ring 81 and the adhesive 41, and the region not contacted by the O-ring 81 and the adhesive 41 among the inner surface of the housing 2. Thus, the rigidity of the inner surface of the housing 2 can be improved in the direction of the rotation shaft 31 of the motor 3, thereby suppressing the propagation of vibration.

In the embodiment, the internal loss of the adhesive 41 being a non-molded member, is greater than the internal loss of the molded O-ring 81 being a molded member. The elastic modulus of the adhesive 41 may be less than the elastic modulus of the O-ring 81. In this case, the viscoelastic property of the O-ring 81 and the adhesive 41 are different from each other in a predetermined frequency band, so that the frequency regions of the vibration allowed to be damped are different from each other. By using a molded member and a non-molded member with frequency bands of the vibration allowed to be damped are different from each other, the vibration can be reduced over a wide frequency band, the generation of noise can be suppressed, and the noise can be reduced.

As illustrated in FIG. 7, the O-ring 81 and the elastic first adhesive 41 are arranged side by side in the radial direction (Z-axis direction) of the motor 3. Thus, the first outer side surface 342 of the tubular body 32 of the motor 3 and the first holding surface 261 of the second housing 22 are coupled by two types of resin having different internal losses in a predetermined frequency band. Thus, the propagation of vibration can be reduced over a wide range of frequency band.

As described above, the rotating device 1 according to the embodiment, includes the motor 3, the gears 5 and 6, the first molded member 81 formed of an elastic resin, the first non-molded member 41 formed of an elastic resin, and the housings 21 and 22. The motor 3 includes the rotation shaft 31 and the frame 30. The housing 22 includes the first inner surface 261 in the rotation shaft direction (X-axis direction) of the motor 3. The frame 30 includes the tubular body 32 including two opening portions in the rotation shaft direction, and the first part 342 covering one of the two opening portions. The first part 342 of the frame 30 is coupled to the first inner surface 261 of the housing 22 opposing the first part 342 of the frame 30 via the first non-molded member 41 in the rotation shaft direction of the motor 3. The frame 30 is supported by the housing 22 via the first molded member 81. Thus, in addition to the O-rings 81 and 82, the motor 3 can be supported by interposing the elastic first adhesive 41 between the outer side surface of the frame 30 and the surface of the holding part intersecting with the X-axis direction, thereby suppressing the generation of abnormal sound.

### Modified Examples

Although the configuration of the present embodiment has been described above, the embodiment is not limited to the above. For example, when the generation of abnormal sound can be suppressed, the structure may be such that only one of the O-rings 81 and 82 is provided.

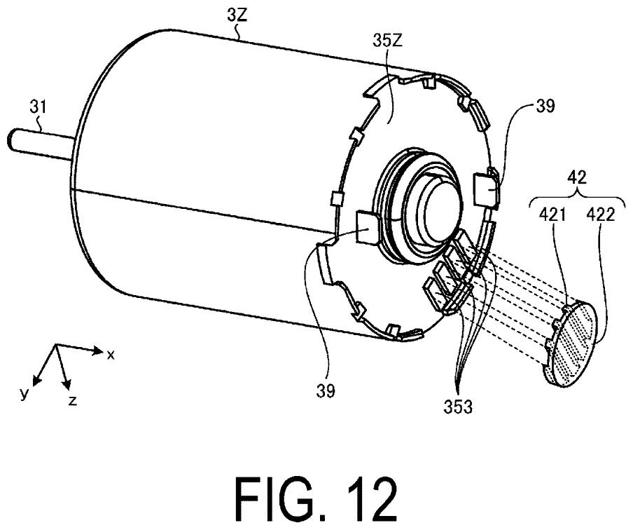

In the rotating device, a terminal 39 or the like illustrated in FIG. 12 is disposed at the opposite end part in the X-axis direction. FIG. 12 is a perspective view illustrating an example of a motor in a modified example. In each of the following modified examples, the same parts as the parts illustrated in the previously described drawings are denoted by the same signs, and overlapping descriptions are omitted.

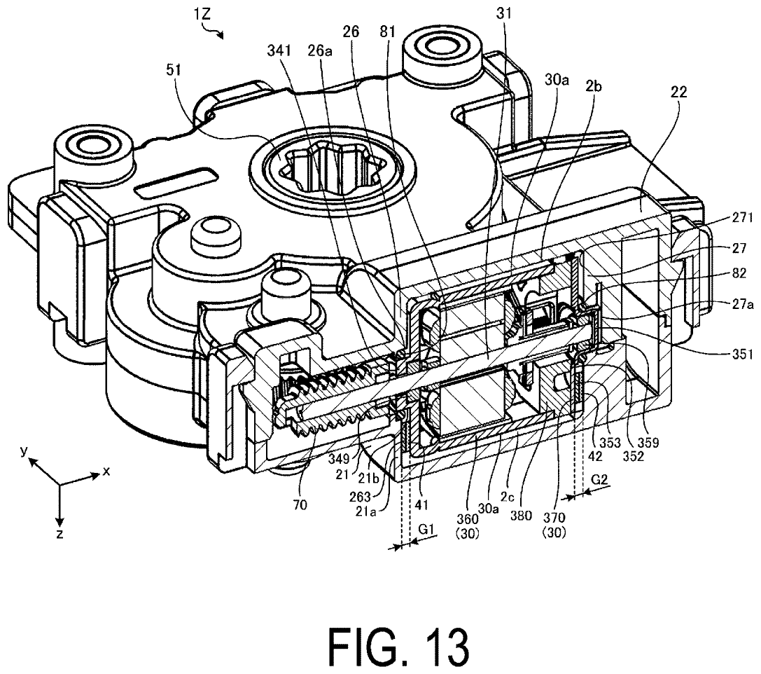

The terminal 39 is connected, for example, to a wiring or a flexible substrate (not illustrated) or the like, and is connected to an external device via the terminal group 4 illustrated in FIG. 4. In this case, when there is no interference of the connection to the terminal 39, as illustrated in FIG. 13, an adhesive having elasticity may also be disposed in the gap G2, located opposite to the gap G1 in the X-axis direction and formed between the second outer side surface 352 and the second holding wall 27 and. FIG. 13 is a side view illustrating an example of a rotating device in a modified example. FIG. 13 is a cross-sectional view of a rotating device 1Z cut in the direction of the rotation shaft of the motor 3Z through the rotation shaft 31 of a motor 3Z. As illustrated in FIGS. 12 and 13, in the modified examples, the elastic adhesives 41 and 42 may be disposed at the first housing 21 instead of the second housing 22. A surface 271 of the second holding wall 27 is an example of the second inner surface.

As illustrated in FIG. 13, the elastic second adhesive 42 is disposed at the gap G2 formed between the second outer side surface 352 of the motor 3Z and the second holding wall 27 of the second housing 22. As a result, the reaction force applied in the axial direction (X-axis direction) of the motor 3Z is absorbed by the elastic second adhesive 42 in addition to the adhesive 41 as the first adhesive, so that the displacement of the motor 3Z in the X-axis direction and the propagation of vibration accompanied by the displacement are suppressed, and noise can be reduced.

In addition, the adhesive having elasticity may be arranged in a place other than the first gap G1 and the second gap G2. The adhesive having elasticity may be arranged in the direction of the rotation shaft, for example, such as between the frame 30 illustrated in FIG. 13 and a bottom surface 2c of the first housing 21, or between the frame 30 and a bottom surface 2b of the second housing 22, rather than in the direction intersecting with the rotation shaft (X-axis direction).

In addition, the uneven shape may be formed in a part other than the first holding surface 261. For example, the uneven shape may be formed in the second holding wall 27, or may be formed at the end part of the motor as illustrated in FIG. 12. In this case, as illustrated in FIG. 12, an uneven shape 353 formed in a second end part 35Z of the motor 3Z is also transferred to a first surface 421 of the elastic second adhesive 42. For example, the shape of the second holding wall 27 illustrated in FIG. 13 is transferred to a second surface 422 of the adhesive 42.

Further, as illustrated in FIG. 12, the motor 3 includes, for example, the tubular body 32 having a substantially circular cross section, but not limited to this, and may be, for example, a so-called “square motor” having a substantially rectangular cross section of the frame.

In the embodiment and the modified examples, the first outer side surface 342 and the O-ring 81 are in contact with each other in the X-axis direction, and the second outer side surface 352 and the O-ring 82 are in contact with each other in the X-axis direction, but the embodiment is not limited to this. For example, the first outer side surface 342 and the O-ring 81 may be apart by a predetermined distance in the X-axis direction, and the second outer side surface 352 and the O-ring 82 may be apart by a predetermined distance in the X-axis direction.

The part of the first holding surface 261 having the uneven shape 263 may be integrally molded with, for example, the second housing 22, but may also be formed by attaching another member to the second housing 22. In this case, it is preferable that installation is performed such that the positional relationship between the part of the first holding surface 261 having the uneven shape 263 and the second housing 22 is not changed due to the displacement, vibration, or the like of the motor 3. The same applies to a part of the second outer side surface 352 having the uneven shape 353 formed at the second end part 35Z of the motor 3Z.

Furthermore, in the present embodiment, the motor 3 need not be in contact with both the whole of the first housing 21 and the whole of the second housing 22, and the motor 3 may be supported by both the first housing 21 and the second housing 22 via the elastic resin members 41. Such a configuration may also suppress the generation of abnormal sound.

Moreover, the configuration illustrated in the present embodiment and each modified example may also be applied to a type of motor 3 with both ends of the rotation shaft 31 projecting from the first end part 34 and the second end part 35 of the motor 3.

Although the present invention has been described above based on the embodiment and each modified example, the present invention is not limited to the embodiment and each modified example, and it is needless to say that various variations can be made without departing from the gist of the present invention. Various variations without departing from such a gist are also included in the technical scope of the present invention, and this is apparent to those skilled in the art from the description of the claims.

### REFERENCE SIGNS LIST

1, 1Z Rotating device; 2 Housing; 3, 3Z Motor; 3a Function section; 4 Terminal group; 5 Output gear; 6 Gear group; 7 Sensor; 21 First housing; 22 Second housing; 26 First holding wall; 26a First recess portion; 27 Second holding wall; 27a Second recess portion; 30 Frame; 31 Rotation shaft; 32 Tubular body; 34 First end part; 35, 35Z Second end part; 39 Terminal; 41 Elastic first adhesive; 42 Elastic second adhesive; 51 Output shaft; 61 First transmission gear; 61a Helical gear; 61b Gear; 62 Second transmission gear; 70 Worm gear; 81, 82 O-ring; 91 Projection part; 92 Fitting hole; 93 Joining piece; 94 Coupling hole; 210 First surface part; 211 First side wall part; 212 Engagement part; 214 Opening portion; 215 Engagement recess portion; 218 Region; 220 Second surface part; 222 Second side wall part; 224 Engagement projection; 226 Opening portion; 228 Region; 261 First holding surface; 281 First through-hole; 282 Second through-hole; 341 First bearing part; 342 First outer side surface; 349 First bearing; 351 Second bearing part; 352 Second outer side surface; 359 Second bearing; 411, 421 First surface; 412, 422 Second surface; G1, G2 Gap

1. A rotating device, comprising:
a motor;
a gear;
a first molded member formed of an elastic resin;
a first non-molded member formed of an elastic resin; and
a housing, wherein
the motor includes a rotation shaft and a frame,
the housing includes a first inner surface in a rotation shaft direction of the motor,
the frame includes:
a tube including two opening portions in the rotation shaft direction; and
a first part covering one of the two opening portions,
the first part of the frame connects to the first inner surface of the housing opposing the first part of the frame via the first non-molded member in the rotation shaft direction of the motor, and
the frame is supported by the housing via the first molded member.

2. The rotating device according to claim 1, wherein
an internal loss of the first non-molded member is greater than an internal loss of the first molded member in a predetermined frequency band.

3. The rotating device according to claim 1, wherein
an elastic modulus of the first non-molded member is smaller than an elastic modulus of the first molded member in a predetermined frequency band.

4. The rotating device according to claim 1, wherein
the first non-molded member has a higher adhesive force than the first molded member.

5. The rotating device according to claim 1, wherein
a force required to remove the first molded member from the housing is smaller than a force required to remove the first non-molded member from the housing.

6. The rotating device according to claim 1, wherein
an uneven shape is formed at a part of the first inner surface in a direction intersecting the rotation shaft direction of the motor, and
the first non-molded member covers the part of the first inner surface.

7. The rotating device according to claim 1, wherein
the frame includes a second part covering the other opening portion of the tube in the rotation shaft direction of the motor,
the housing includes a second inner surface opposing the second part of the frame in the rotation shaft direction of the motor, and
a first gap is provided one of between the first inner surface and the first part of the frame, and between the second inner surface of the housing and the second part of the frame.

8. The rotating device according to claim 7, wherein
the first non-molded member is provided within the first gap.

9. The rotating device according to claim 8, comprising a second non-molded member, wherein
a second gap is provided the other of between the first inner surface and the first part of the frame, and between the second inner surface and the second part of the frame, and
the second non-molded member is provided within the second gap.

10. The rotating device according to claim 7, wherein
the frame includes, in the rotation shaft direction of the motor, a first end part on the first part side and a second end part on the second part side,
the housing includes a first support part and a second support part,
the first molded member has an annular shape,
the first molded member surrounds the first end part or the second end part, and
the first support part or the second support part supports the first end part or the second end part via the first molded member.

11. The rotating device according to claim 10, comprising a second molded member having an annular shape, wherein
the first molded member surrounds the first end part,
the second molded member surrounds the second end part,
the first support part supports the first end part via the first molded member,
the second support part supports the second end part via the second molded member,
the first support part is disposed, in an axial direction, apart from the first part of the frame, and
the second support part is disposed, in the axial direction, apart from the second part of the frame.

12. The rotating device according to claim 7, wherein
the first non-molded member has a shape transferred from a shape of the first inner surface and the first part of the frame or from a shape of the second inner surface and the second part of the frame.

13. The rotating device according to claim 1, wherein
the elastic resin is a rubber-based resin material, a silicon-based resin material, a modified silicon-based resin material, a urethane-based resin material, or an epoxy-based resin material.
